(19) United States
(12) Patent Application Publication
(10) Pub. No.: US 2004/0045682 A1
(43) Pub. Date: Mar. 11, 2004

(54) Cogeneration wasteheat evaporation system and method for wastewater treatment utilizing wasteheat recovery

(76) Inventor: Randal Liprie, Lake Charles, LA (US)

Correspondence Address: CANTOR COLBURN, LLP, 55 GRIFFIN ROAD SOUTH, BLOOMFIELD, CT, 06002

(21) Appl. No.: 10/422,349

(22) Filed: Apr. 24, 2003

Related U.S. Application Data
(60) Provisional application No. 60/375,845, filed on Apr. 24, 2002.

(51) Int. Cl. B01D 1/00

(52) U.S. Cl. 159/31

(57) ABSTRACT

A cogeneration waste heat evaporation system and method for wastewater treatment utilizing waste heat recovery from, e.g., a gas turbine, is described, comprising recovering engine waste heat by capturing and routing such waste heat through a unique evaporator system. Such evaporation system may include one or more of a bypass throttle system, which controls the flow such exhaust through one or both of a bypass duct and an evaporator duct, at least one electrical thermal resistance heater operated to modulate demand on the engine, and thus, modulate output of waste heat into the evaporation system and/or to provide additional heat for the evaporation and/or drying process, and a downstream afterburner utilized in conjunction with a gas turbine engine.

### CROSS REFERENCE TO RELATED APPLICATIONS

The present application claims priority to U.S. Provisional Patent Application Serial No. 60/375,845, filed Apr. 24, 2002, the entire contents of which are expressly incorporated herein by reference in its entirety.

### BACKGROUND

Currently, there are a variety of methods utilized to treat wastewater, or leachate. Such methods may include, for example, bio-treatment facilities, options for offsite deepwell injection, onsite wastewater evaporation, and the like.

One exemplary method of leachate wastewater evaporation utilizes evaporation ponds. However, these leachate wastewater systems may be used only in dry climates. Another exemplary method of leachate wastewater evaporation utilizes landfill gas extraction facilities, which use methane gas extracted from refuse type landfills. In such a system, leachate wastewater is fired in a fuel demand type evaporation system.

A more versatile and more efficient leachate wastewater evaporation system would be greatly desired by the art.

### SUMMARY

The above discussed and other drawbacks and deficiencies of the prior art are overcome or alleviated by the described cogeneration waste heat evaporation system and method for wastewater treatment utilizing waste heat recovery from, e.g., a gas turbine. Such method comprises recovering engine waste heat by capturing and routing such waste heat through a unique evaporator system.

In one exemplary embodiment, the evaporator system collects exhaust through a bypass throttle system, which controls the flow such exhaust through one or both of a bypass duct and an evaporator duct. In another exemplary embodiment, such bypass throttle system controls the rate of evaporation by selectively varying the amount of waste heat provided to the evaporator and by routing excess undesired amounts of exhaust through a bypass duct. In another exemplary embodiment, the bypass throttle directs substantially all of the waste heat through the bypass duct to allow the evaporator system to be taken offline, while maintaining the performance of the engine generating such waste heat.

In another exemplary embodiment, an electrical generator tied to the engine, e.g., a gas turbine, is tied to one of at least one electrical thermal resistance heater and at least one electric dryer. In such system, the at least one heater and/or at least one dryer may be operated to modulate demand on the engine, and thus, modulate output of waste heat into the evaporation system. Such configuration may be particularly advantageous where demand on the electric generator is otherwise low enough to reduce the output of waste heat into the evaporator system to less than desirable levels.

In another exemplary embodiment, such at least one electrical thermal resistance heater is submerged in the leachate wastewater to be evaporated. In such a scenario, the at least one heater may be used not only to modulate demand on the engine, but also to increase evaporation capacity by providing an additional heat energy input for the leachate wastewater.

In another embodiment, the electrical generator tied to the engine, e.g., a gas turbine, is intertied to a municipality for resale of excess electricity to the municipality. In such system, the output of the exhaust may be maintained in a desired range by demanding varying amounts of electricity from the electrical generator for resale to the municipality.

In another embodiment, a downstream afterburner is utilized in conjunction with a gas turbine engine. The afterburner is positioned between the evaporator and/or the bypass duct and the atmosphere outlet. Such afterburner burns the excess oxygen carried in the exhaust stream. Combustion provided by the afterburner is effective to both increase stack gas compression and to achieve higher atmospheric release height of constituents (with a given stack height) to provide better atmospheric dispersion.

The above discussed and other features and advantages of the present cogeneration waste heat evaporation system and method for wastewater treatment utilizing waste heat recovery will be appreciated and understood by those skilled in the art from the following detailed description and drawing.

### BRIEF DESCRIPTION OF THE DRAWINGS

Referring now to the drawing, wherein like elements are numbered alike in the FIGURES:

FIG. 1 depicts in plan view an exemplary wastewater evaporation system with cogeneration.

### DETAILED DESCRIPTION

Reference will now be made in detail to the preferred embodiments of the present invention, examples of which are illustrated in the accompanying drawing.

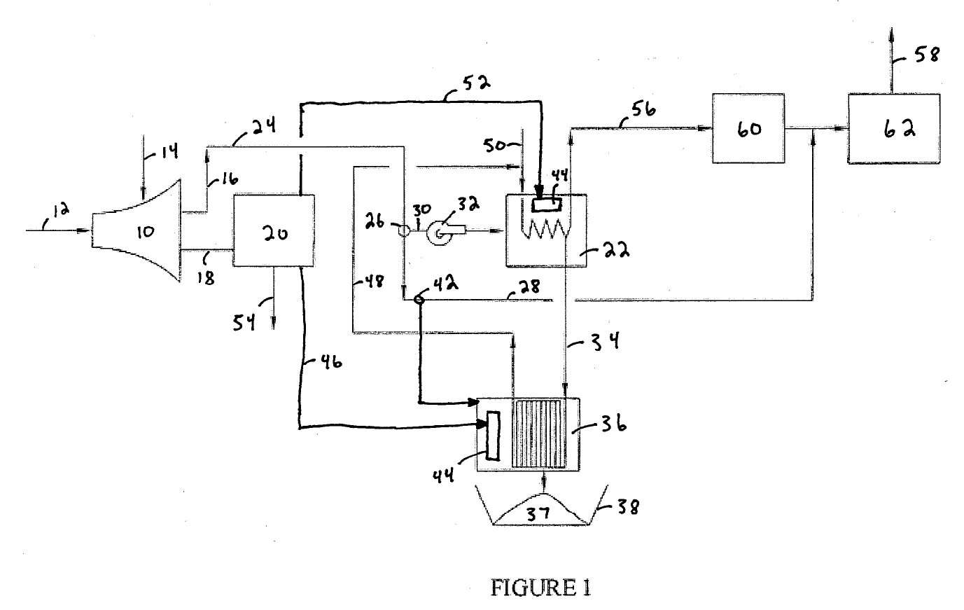

Referring now to FIG. 1, an exemplary cogeneration waste heat evaporation system and method for wastewater treatment utilizing waste heat recovery is illustrated. A fuel fired turbine engine 10 is provided with a turbine air inlet 12, a fuel inlet 14, a turbine exhaust outlet 16 and a connection 18 to an electric generator 20. While a fuel fired turbine engine 10 is described with reference to an exemplary embodiment, it should be recognized that any heat engine that does useful work may be utilized. The presently described system finds particular application with turbine engines since a large proportion of fuel input energy is typically lost as waste. For turbine engines, thermal efficiency ranges near 25%. Thus, approximately 75% of the input fuel energy to escapes in the form of waste heat through the engine exhaust system. The presently described system and method routes this otherwise unused waste heat through the turbine exhaust outlet 16 and to a waste heat recovery evaporator 22.

The turbine 10 generally works on the theoretical principal of the Brayton Cycle (thermodynamically speaking). This type of engine provides generous amounts of waste heat in the form of hot gas/air. Without limitation, the waste heat exhaust temperatures will generally range between 850-1100 F°. The turbine may provide primary work energy by spinning a shaft (not shown). This shaft contains useful mechanical energy that can be coupled to the illustrated electric generator 20 and/or to any other useful function requiring shaft energy. In one exemplary embodiment, a turbine is utilized producing above about 0.75 Megawatt of power.

The waste heat exhaust stream is ducted into and through the evaporator and or bypass system as will be described below in more detail. In one exemplary embodiment, such ducting is via heat resistant piping, for example, constructed of high temperature alloy steels such as stainless steel, hastalloy, etc.

In one exemplary embodiment, a bypass throttle system is provided between the exhaust outlet 16 and the waste heat recovery evaporator 22. Referring again to the exemplary embodiment illustrated by FIG. 1, the turbine exhaust is routed, via introductory duct 24, to a flow control damper valve 26. In one exemplary embodiment, the flow control damper valve 26 selectively controls the flow of exhaust through one or both of a bypass duct 28 and an evaporator duct 30. The term “flow control damper valve” is not intended to be limited, but is intended to encompass any kind of valve that performs diversion or equivalents.

In another exemplary embodiment, such flow control damper valve 26 controls the rate of evaporation in the waste heat recovery evaporator 22 by selectively varying the amount of waste heat provided to the evaporator 22 through the evaporator duct 30 and by routing excess, undesired amounts of exhaust through the bypass duct 28. Such embodiment permits throttling of the exhaust through the evaporator 22 at a controlled rate and allows the evaporator boiling rate to be scaled up or down depending on operational preferences.

In another exemplary embodiment, the flow control damper valve 26 directs substantially all of the waste heat through the bypass duct 28 to allow the evaporator 22 to be taken offline, while maintaining the performance of the engine 10 generating such waste heat. Such embodiment permits the engine 10 to continue to operate, thereby not creating, for example, an electrical outage while the evaporator 22 is offline.

In another exemplary embodiment, exhaust provided by the flow control damper valve 26 to the evaporator duct 30 is passed through a high temperature blower fan 32 prior to entering the evaporator 22. In one exemplary embodiment, the blower fan 32 may be selectively configured to transfer up to and including 100 percent of the turbine waste heat. In another embodiment, the blower fan 32 may be selectively configured to maintain a turbine exhaust backpressure to optimize the performance of the turbine engine. For example, the blower fan 32 may be controlled to maintain about six inches of water pressure for the turbine exhaust back pressure and to increase air stream static pressure to a higher pressure state, for example, between about 15 and 48 inches of water pressure.

Referring again to FIG. 1, the exhaust directed through the evaporator duct 30 is further directed into the evaporator 22. The evaporator 22 may be configured as a heat exchanger either to transfer of heat directly or indirectly (e.g., via metal tubes, plates, etc.) to the leachate wastewater. In one exemplary embodiment, the evaporator 22 comprises a direct contact submerged tube type heat exchanger. In such embodiment, the exhaust is ducted into the evaporator 22 such that hot exhaust percolates directly through the leachate wastewater, thus providing for heating and/or boiling of the leachate wastewater. In another embodiment, the heating/boiling process in the evaporator 22 takes place at approximately atmospheric pressure and at temperatures between about 195 and 220 degrees Fahrenheit.

During evaporation of the leachate wastewater, the wastewater in the evaporator 22 begins to concentrate with dissolved and suspended particles of solid materials. In one embodiment, when concentration levels of the wastewater increase to approximately 40 percent to 60 percent, the solid particles and/or concentrated wastewater are removed from the bottom of the evaporator (removal may be effected, for example, by a liquid slurry pump or a material auger, depending on the type of concentrates in the wastewater stream). Removal of such solid particles and/or concentrated wastewater is shown generally at 34.

Such particles and/or wastewater may then be subjected to a dewatering device 36 for final moisture removal. In one embodiment, the dewatering device 36 generally comprises a device effective to further remove water from solids/concentrated wastewater. For example, the solids/concentrated wastewater can be directed into a dewatering device, comprising a filter press, drying vat or batch tank.

In another exemplary embodiment, this tank utilizes surplus waste heat from the turbine process to dry the solids for future treatment and/or proper disposal. Such surplus exhaust heat may be selectively ducted into a dewatering exhaust duct 40 from the bypass duct 28 via a second flow control valve 42 to provide such heating.

In another exemplary embodiment, this tank utilizes at least one electrical resistance heater 44, or electric dryer, to dry the solids 37 for future treatment and/or proper disposal. Such heater 44 may be powered by electrical connection 46 to electric generator 20. The electrical resistance heater 44 may incorporate variable heat controls which may be tailored To the needs of the dewatering device and, as will be discussed in more detail below (with regard to optional placement of resistance heaters 44 in the evaporator 22), to modulate the demand on the engine 10 and the related production of exhaust.

Subsequent to dewatering, the solids 37 may be removed and collected into suitable portable container 38. Wastewater removed from the dewatering process may be ducted through a return duct 48 and reintroduced either into the initial wastewater stream 50 or directly into the evaporator 22.

Referring again to FIG. 1, in another exemplary embodiment, at least one electrical resistance heater 44 may be provided in the evaporator 22. Such heater 44 may be powered by electrical connection 52 to electric generator 20. The electrical resistance heater 44 may incorporate variable heat controls that regulate the additional heat added to the wastewater in the evaporator and modulate the demand on the engine 10 and the related production of exhaust. Specifically, the heater 44 may transfer electric energy into thermal energy and may be submerged in the wastewater or liquid in the evaporator 22. The electric thermal resistance heater 44 also provides a means of compensating for electrical load variations and demand changes on the electric generator 20. As general electrical usage (demand) decreases over the course of a given operational period, the engine 10 would do less work turning the electric generator 20.

This condition would result in less available waste heat as less work is being done. The exemplary electric thermal resistance heater 44 may be staged in via controls, to maintain an optimal demand on the generator 20 to increase engine temperature, decrease engine temperature, or minimize variations in engine temperature.

The exemplary inclusion of at least one heater 44, as described above, finds particular application in remote locations, where electrical interconnection to a municipal power system is not feasible and/or available. This exemplary inclusion also finds application in situations wherein local demand on the engine (draw on electrical generator output 54) is not sufficient to run the engine at optimal levels for production of evaporation waste heat.

Referring again to the exemplary system illustrated by FIG. 1, the water vapor evaporated from the evaporator 22 is ducted via a post-evaporation duct 56 for release into the atmosphere at a release port or stack 58. In one exemplary embodiment, the water vapor/gas being removed from the evaporator 22 or within the post-evaporation duct 56 is treated, e.g., with one or more demister pads, thermal oxidizers and chemical scrubbers 60. In another exemplary embodiment, at a point between the evaporator 22 and the release port or stack 58, the exhaust in the bypass duct 28 is combined with the water vapor/gas in the post-evaporation duct 56.

In another exemplary embodiment, one or both of the water vapor/gas in the post-evaporation duct 56 and the bypass duct 28 may also be processed in an afterburner 62, provided upstream of the release port or stack 58. Such embodiment finds particular use with gas turbine exhaust, which typically contains 18 percent to 20 percent excess air in the exhaust stream. This excess air contains enough oxygen to promote further combustion when combined with supplemental fuel in the afterburner. Combustion in the afterburner 62 may serve to superheat the water vapor and provide means of controlling emissions of chemical constituents and foul odors, respectively, in the exhaust stack 58. Combustion provided by the afterburner 62 is also effective to both increase stack gas compression and to achieve higher atmospheric release height of constituents (with a given stack height) to provide better atmospheric dispersion.

It will be apparent to those skilled in the art that, while exemplary embodiments have been shown and described, various modifications and variations can be made in the present board game without departing from the spirit or scope of the invention. For example, without limitation, dewatering control, use of air scrubbers, use of the afterburner for odor control, among others, include optional components/compositions in recognition of the fact that various waste streams comprise varying chemical constituents, total solids (dissolved and suspended), and air emission characteristics that certain of the above described and other optional devices may be advantageously suited for. Indeed, the above described, and below claimed, system and method finds application in a broad range of fields, including without limitation, processing of wastewater generated from rainfall infiltrating hazardous, non-hazardous, etc. landfills, and other sources such as bio-medical wastewater streams, oilfield effluent wastewater streams, onshore and offshore industrial oil/gas industrial platforms, municipal wastewater effluent, etc. Accordingly, it is to be understood that the various embodiments have been described by way of illustration and not limitation.

What is claimed is:

1. A cogeneration waste heat evaporation system, comprising:
an engine capable of providing waste heat in the form of exhaust;
a waste heat recovery evaporator configured to receive waste heat from the engine, the evaporator comprising a wastewater inlet, an exhaust inlet, a heat exchanger, a vapor outlet, and a concentrated wastewater or waste solids outlet;
a release port or stack configured to release vapor or gas provided by one or both of the evaporator and the engine; and
a selectable exhaust bypass, provided between the engine and a release port or stack, the exhaust bypass selectable to divert exhaust around the evaporator and to the release port or stack.

2. The system in accordance with claim 1, wherein the exhaust bypass contains a throttle control, wherein the relative amounts of exhaust provided to the evaporator and diverted around the evaporator are controlled by the throttle control.

3. The system in accordance with claim 2, wherein the throttle control comprises a flow control damper valve.

4. The system in accordance with claim 1, wherein the selectable exhaust bypass comprises a flow control valve, which selectively controls the amount of exhaust provided to the evaporator and which diverts excess exhaust through a bypass duct.

5. The system in accordance with claim 3, further comprising a high temperature blower fan positioned between the flow control damper valve and the evaporator.

6. The system in accordance with claim 5, wherein the blower fan is selectively configured to transfer up to and including 100 percent of the engine waste heat.

7. The system in accordance with claim 5, wherein the blower fan is selectively configured to maintain an engine exhaust backpressure.

8. The system in accordance with claim 7, wherein the blower fan is selectively configured to maintain an engine exhaust back-pressure of between about five and seven inches of water pressure.

9. The system in accordance with claim 5, wherein the blower fan is configured to increase air stream static pressure to between about 15 and 48 inches of water pressure.

10. The system in accordance with claim 1, wherein the engine is a gas turbine engine coupled to an electric generator.

11. The system in accordance with claim 1, wherein the evaporator comprises a direct contact submerged tube type heat exchanger.

12. The system in accordance with claim 11, wherein the exhaust is ducted into the evaporator such that hot exhaust percolates directly through wastewater provided via the wastewater inlet.

13. The system in accordance with claim 1, further comprising a dewatering device configured to receive materials from the concentrated wastewater or waste solids outlet.

14. The system in accordance with claim 13, wherein the dewatering device comprises one of a filter press, a drying vat, and a batch tank.

15. The system in accordance with claim 13, wherein the dewatering device includes an exhaust inlet, configured to receive diverted exhaust gas.

16. The system in accordance with claim 13, wherein the dewatering device includes at least one electrical resistance heater or electric dryer.

17. The system in accordance with claim 16, wherein the at least one electrical resistance heater or electric dryer is electrically coupled to an electric generator driven by the engine.

18. The system in accordance with claim 17, wherein the electrical resistance heater includes a variable output control.

19. The system in accordance with claim 13, wherein the dewatering device includes a concentrated wastewater outlet and a wastewater return duct, the concentrated wastewater outlet and the wastewater return duct configured to return excess wastewater liquid to the evaporator.

20. The system in accordance with claim 1, wherein the evaporator further comprises at least one electrical resistance heater.

21. The system in accordance with claim 20, wherein the electrical resistance heater is provided in an at least partially submerged position within wastewater provided in the evaporator through the wastewater inlet.

22. The system in accordance with claim 20, wherein the at least one electrical resistance heater is electrically coupled to an electric generator driven by the engine.

23. The system in accordance with claim 22, wherein the electrical resistance heater includes a variable output control.

24. The system in accordance with claim 1, further comprising at least one of a chemical scrubber, a demister pad, a thermal oxidizer, and an afterburner provided between the vapor outlet and the release port or stack.

25. A cogeneration waste heat evaporation system, comprising:
an engine capable of providing waste heat in the form of exhaust, the engine connected to an electric generator;
a waste heat recovery evaporator configured to receive waste heat from the engine; and
at least one electrical resistance heater provided in the evaporator, the electrical resistance heater connected to the electric generator.

26. The system in accordance with claim 25, wherein the evaporator comprises a wastewater inlet, and wherein the electrical resistance heater is provided in an at least partially submerged position within wastewater provided in the evaporator through the wastewater inlet.

27. The system in accordance with claim 25, wherein the electrical resistance heater includes a variable output control.

28. The system in accordance with claim 25, wherein the engine is a gas turbine engine.

29. A cogeneration waste heat evaporation system, comprising:
an engine capable of providing waste heat in the form of exhaust, the engine connected to an electric generator;
a waste heat recovery evaporator configured to receive waste heat from the engine;
a dewatering device configured to receive at least one of concentrated wastewater and solids particles from the waste heat recover evaporator; and
at least one electrical resistance heater provided in the dewatering device, the electrical resistance heater connected to the electric generator.

30. The system in accordance with claim 29, wherein the electrical resistance heater includes a variable output control.

31. The system in accordance with claim 29, wherein the engine is a gas turbine engine.

32. The system in accordance with claim 29, wherein the dewatering device comprises one of a filter press, a drying vat, and a batch tank.

33. A cogeneration waste heat evaporation system, comprising:
a gas turbine engine capable of providing waste heat in the form of exhaust;
a waste heat recovery evaporator configured to receive waste heat from the engine;
a release port or stack configured to release at least one of vapor and gas provided by at least one of the evaporator and the gas turbine engine; and
an afterburner provided between the waste heat recover evaporator and the release port or stack, the afterburner configured to burn at least one of vapor and gas provided from at least one of the evaporator and the gas turbine engine.

34. A method for wastewater treatment utilizing waste heat recovery, comprising:
providing exhaust waste heat from an engine to a selectable exhaust bypass;
directing wastewater into a waste heat recovery evaporator;
directing at least a portion of such exhaust waste heat to the waste heat recovery evaporator; and
releasing at least one of vapor and gas produced by the waste heat recovery evaporator into the atmosphere.

35. The method of claim 34, further comprising directing exhaust heat into a bypass duct to perform at least one of directing exhaust gas around the evaporator and decreasing the operational temperature of the waste heat recovery evaporator.

36. The method of claim 34, further comprising directing substantially all exhaust heat into a bypass duct such that the waste heat recovery evaporator is isolated from the exhaust heat.

37. A method for wastewater treatment utilizing waste heat recovery, comprising:
providing exhaust waste heat from an engine to a waste heat recovery evaporator;
directing wastewater into a waste heat recovery evaporator; and
applying heat energy input to the wastewater in the evaporator with at least one electrical resistance heater provided in the evaporator, wherein the at least one electrical resistance heater is electrically coupled to an electric generator associated with the engine.

38. The method of claim 37, further comprising varying the output of the at least one electrical resistance heater applying heat energy input to the material within the evaporator.

39. The method of claim 37, further comprising varying the output of the at least one electrical resistance heater either to increase the electrical load on the electric generator or to decrease the electrical load on the electric generator.

40. A method for wastewater treatment utilizing waste heat recovery, comprising:
providing exhaust waste heat from an engine to a waste heat recovery evaporator;
directing wastewater into a waste heat recovery evaporator;
directing at least a portion of such exhaust waste heat to the waste heat recovery evaporator; and
dewatering concentrated wastewater and or solids particles produced in the waste heat evaporator, wherein the dewatering is assisted by at least one electrical resistance heater provided in the dewatering device, wherein the at least one electrical resistance heater is electrically coupled to an electric generator associated with the engine.

41. The method of claim 40, further comprising varying the output of the at least one electrical resistance heater applying heat energy input to the material within the dewatering device.

42. The method of claim 40, further comprising varying the output of the at least one electrical resistance heater either to increase the electrical load on the electric generator or to decrease the electrical load on the electric generator.

43. A method for wastewater treatment utilizing waste heat recovery, comprising:
providing exhaust waste heat from a gas turbine engine to a waste heat recovery evaporator;
directing wastewater into a waste heat recovery evaporator;
burning at least one of vapor and gas provided from at least one of the evaporator and the gas turbine engine in an afterburner device provided between the waste heat recover evaporator and a release port or stack; and
releasing at least one of vapor and gas produced by the waste heat recovery evaporator into the atmosphere.
